(19) United States
(12) Patent Application Publication
(10) Pub. No.: US 2016/0317902 A1
(43) Pub. Date: Nov. 3, 2016

(54) SKATEBOARD WHEEL CAP

(71) Applicant: Donald Edward Janocha, Wall, NJ (US)

(72) Inventor: Donald Edward Janocha, Wall, NJ (US)

(21) Appl. No.: 14/698,816

(22) Filed: Apr. 28, 2015

(51) Int. Cl. A63C 17/00; A63C 17/01; B60B 7/00; F16B 37/14

(52) U.S. Cl. CPC A63C 17/002; F16B 37/14; A63C 17/014; B60B 7/0013

(57) ABSTRACT

The present invention relates to skateboard wheel nuts and bearings and, more particularly, to skateboard wheel caps that cover the wheel nuts.

Skateboard wheels are generally held on a truck axle by a 5/16″ nut. The nut leaves the bearing case exposed to the elements and skateboard owners may find the nut visually unappealing. Currently, devices considered to be skateboard hubcaps or wheel covers require permanent locking fixtures to be installed. Additionally, they may also leave the nut exposed. These devices may be complicated to install and may not fit a variety of wheel sizes if they attach to the bearing instead of the nut.

As can be seen, there is a need for a device that protects the skateboard nut so that it is not exposed to the elements and may provide a visual substitute to the wheel nut itself.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a skateboard wheel nut cap that comprises a cap comprising a cavity, an external wall and an internal wall; at least one axial magnet attached to the interior wall of the cap; a retaining ring attached to the cap; and a design cover attached to the external wall of the cap.

As is illustrated in FIGS. 1 through 9, the cap 1 has a cavity that may fit over commonly used skateboard wheel systems. The axial magnets 2 may be secured between internal walls of the cap 1 and a retaining ring 3. A design cover 4 is attached to the outside of the cap 1. The present invention may be attached by placing over the nut. Walls within the cap 1 may be strategically placed to fit snugly around the nut and place axial magnets 2 in an optimal position to adequately secure the cap 1 to the nut through magnetic force. There is a cavity that extends beyond the nut that may cover varying lengths of axles that may extend beyond the nut. The use of axial magnets 2 may provide easy attachment and removal for skateboard owners. The outside, or design cover 4 and cap 1 of the present invention may reduce elemental exposure to the bearing case and provide visual appeal to the skateboard owner.

The top of the cap 1 has a diameter larger than the base that may prevent elements such as pebbles from damaging the bearings of a common skateboard wheel system. The smaller diameter of the cap 1 base may allow the cap 1 to fit common skateboard wheel systems. The cap 1 has internal walls that may snugly fit the cap 1 over the standard 5/16″ nut that is used to secure common skateboard wheels and bearings to the axle of a skateboard truck. The cavity of the cap 1 may extend beyond the top of a standard 5/16″ skateboard nut to provide space for a skateboard axle that extends beyond the nut. Walls within the cap 1 may also act as barriers to secure the position of the axial magnets 2 inside the cap 1. A retaining ring 3 may be attached to the cap 1 as an additional barrier to secure the axial magnet 2. The top of the cap 1 may have indents to assist in the securing of a design cover 4 onto the outside of the cap 1 for visual appeal.

The present invention may be made from a material such as plastic via an injection molding process. The axial magnets may be secured within the cap in a position where they may provide enough magnetic force to hold the cap to the 5/16″ nut of a skateboard wheel system. The retaining ring may lock into the bottom of the cap to keep the magnets in place. The design cover may be attached to the top of the cap with an adhesive or may be designed to snap or lock onto the cap.

In an alternate embodiment, the retaining ring may be substituted with another element that would secure the magnets inside the cap. The design cover allows for visual appeal. The size and shape of the cap may be altered externally. The retaining ring may possibly be replaced by an alternative element to secure the axial magnets. In alternate embodiments, a design may be placed directly on the cap instead of using a design cover that attaches to the cap. A person may then attach the present invention by placing it over a 5/16″ nut commonly used in skateboard wheel systems to provide visual appeal and protection from the elements.

It should be understood, of course, that the foregoing relates to exemplary embodiments of the invention and that modifications may be made without departing from the spirit and scope of the invention as set forth in the following claims.

### BRIEF DESCRIPTION OF THE DRAWINGS

FIG. 1 is a side view of a cap component of an exemplary embodiment of the present invention;

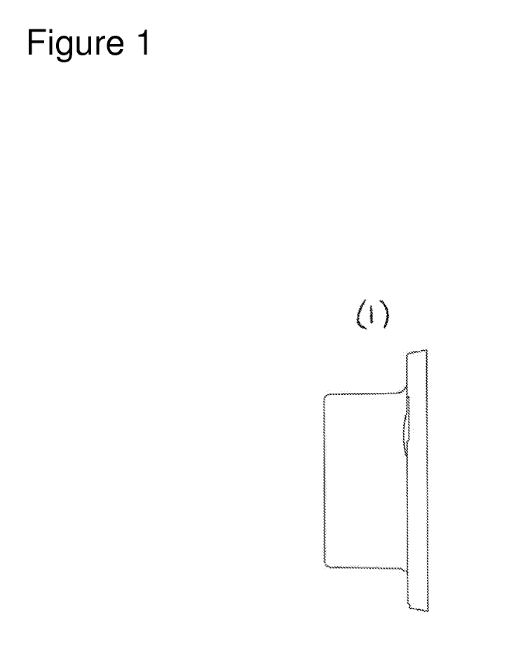

FIG. 2 is a front view of a cap component of an exemplary embodiment of the present invention;

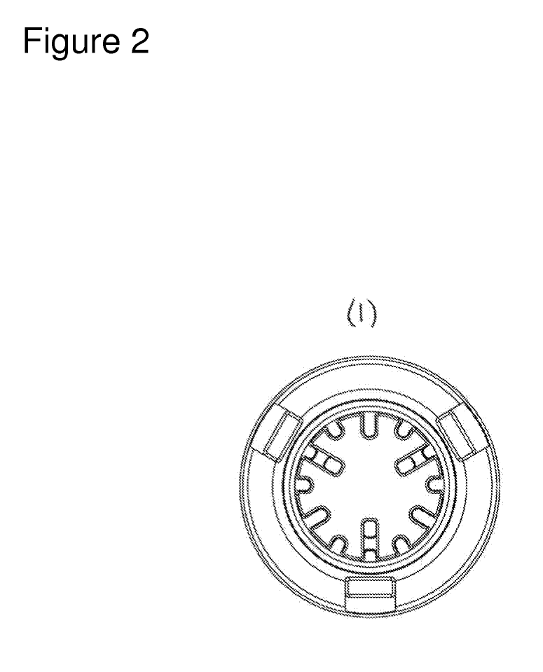

FIG. 3 is a front perspective view of a cap component of an exemplary embodiment of the present invention;

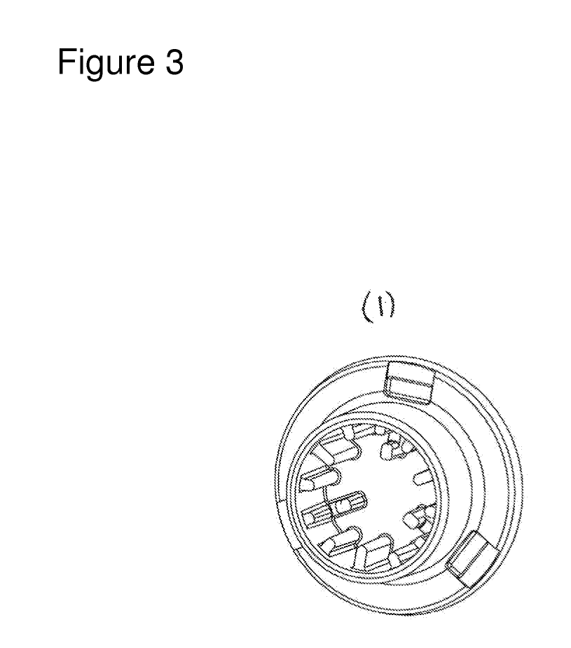

FIG. 4 is a sectional view of a cap component of an exemplary embodiment of the present invention;

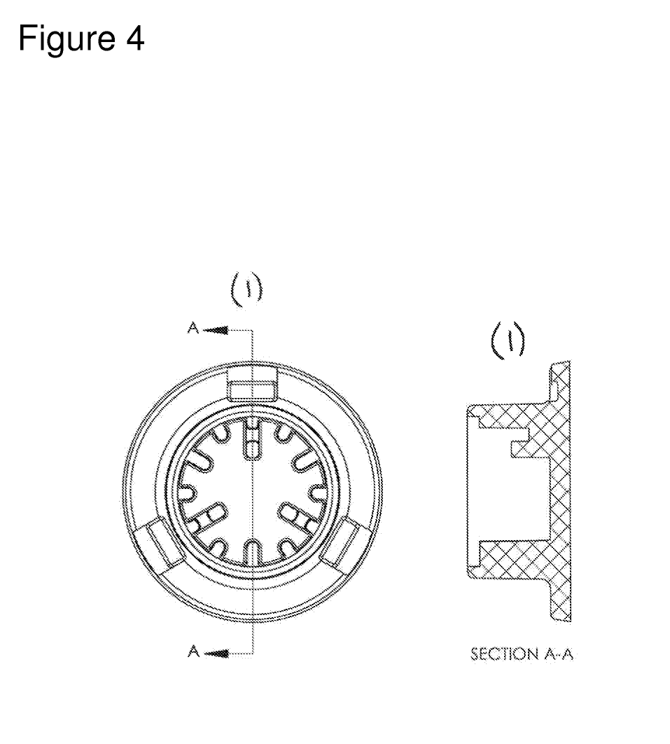

FIG. 5 is a front view of a design cover component of an exemplary embodiment of the present invention;

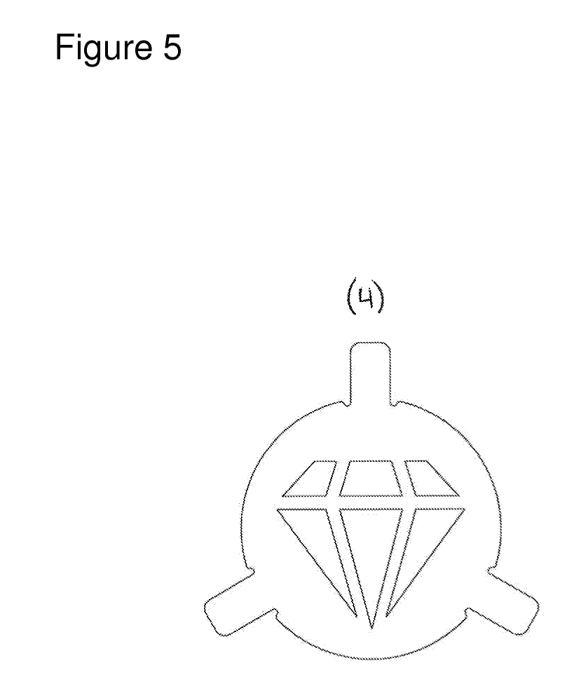

FIG. 6 is are various views of a retaining ring of an exemplary embodiment of the present invention;

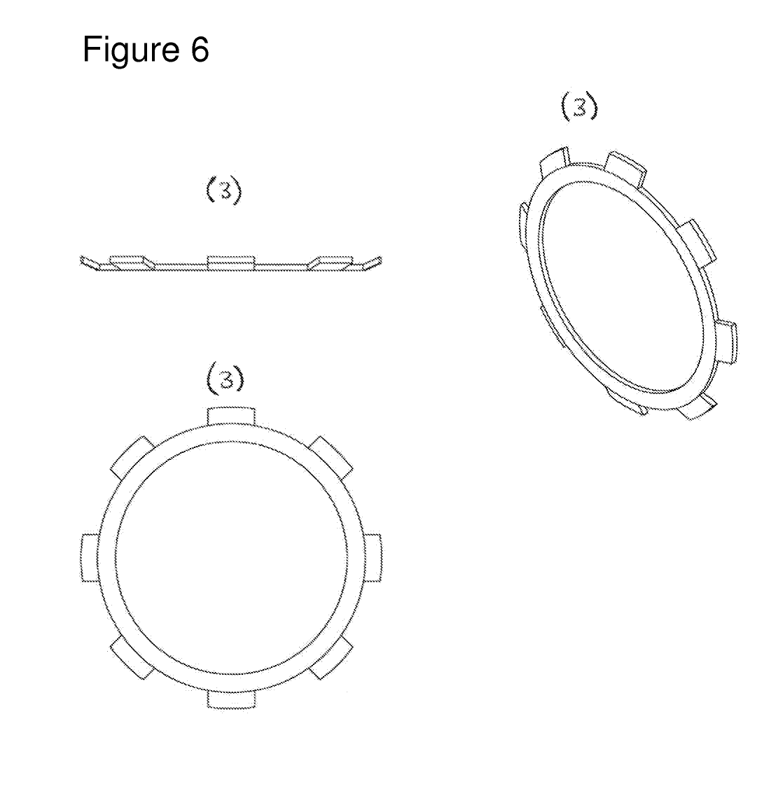

FIG. 7 is a front exploded view of an exemplary embodiment of the present invention;

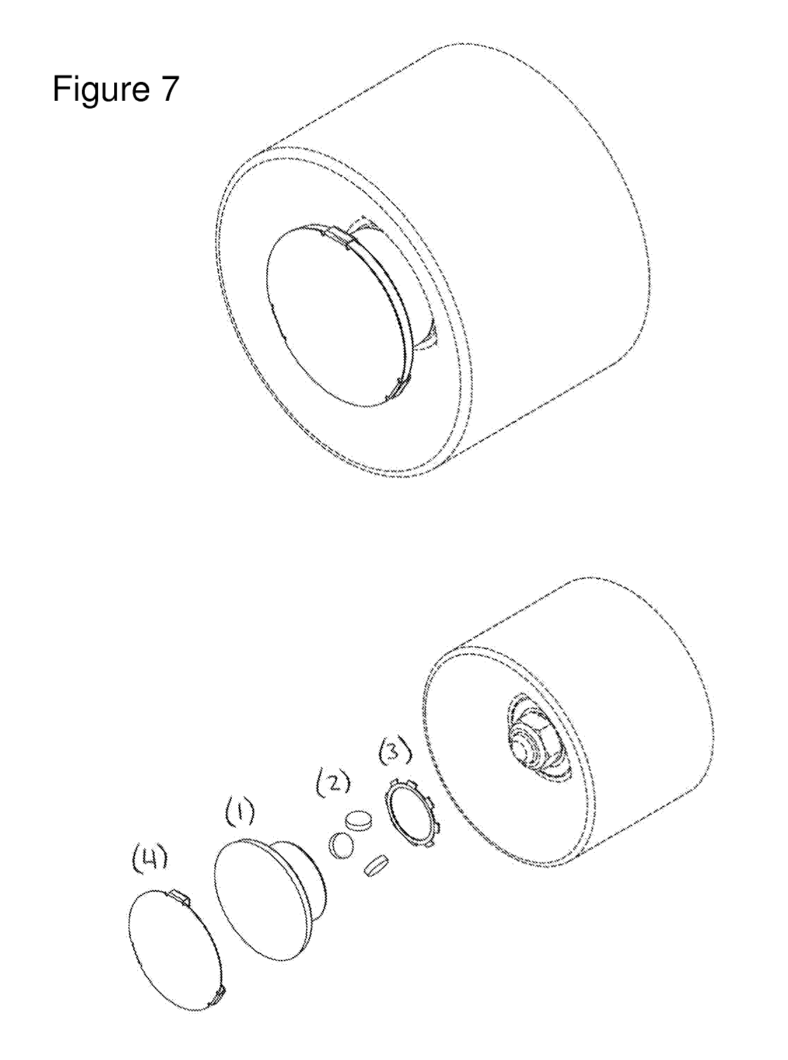

FIG. 8 is a front exploded view of an exemplary embodiment of the present invention; and

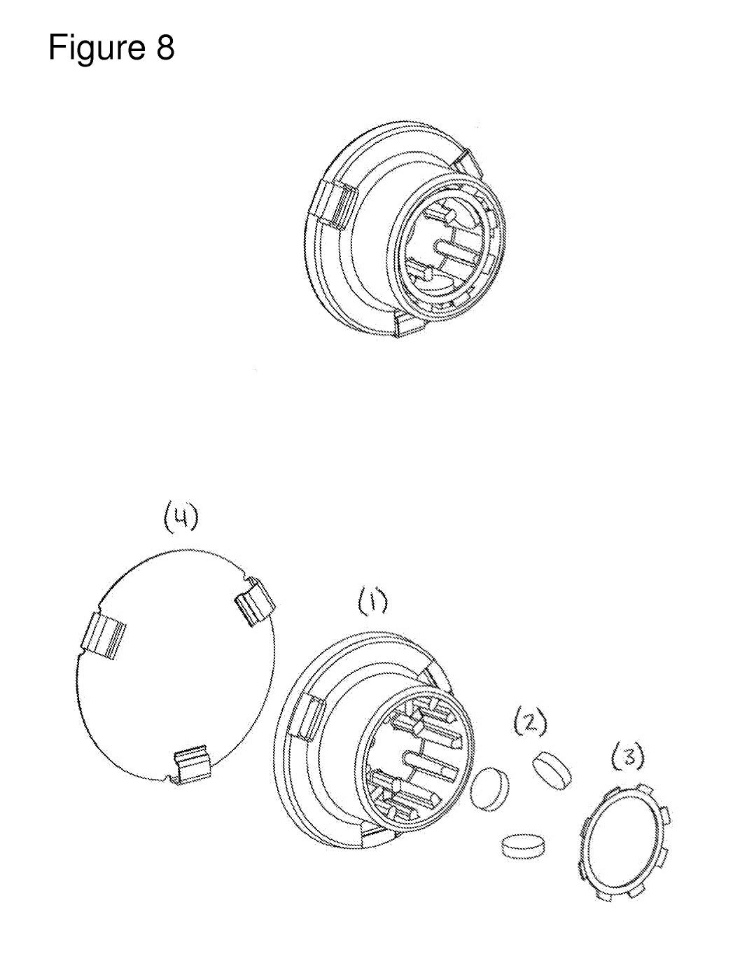

FIG. 9 is a sectional view of an exemplary embodiment of the present invention

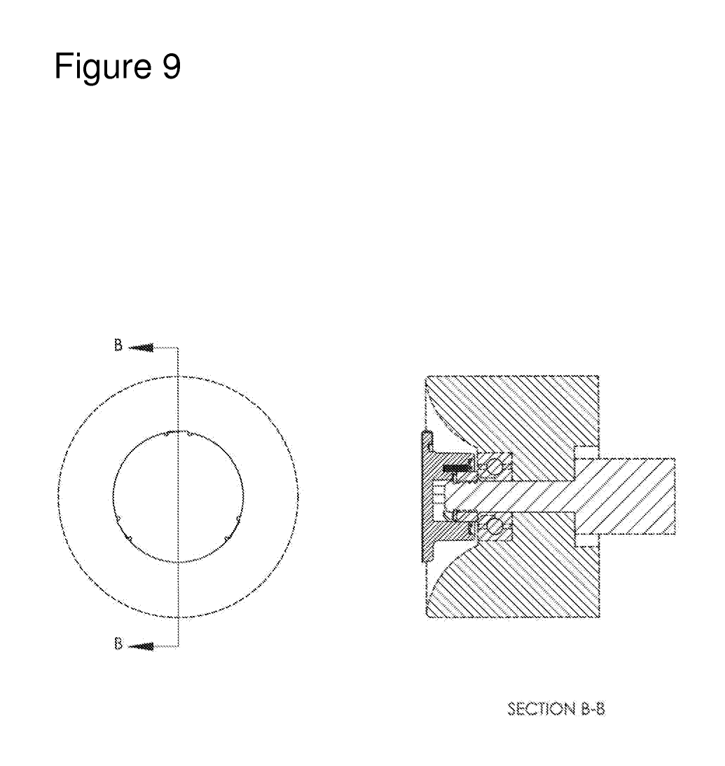

What is claimed is:

1. A skateboard wheel cap comprising:
a cap comprising a cavity, an external wall and an internal wall;
at least one axial magnet attached to the interior wall of the cap;
a retaining ring attached to a cap wherein at least one axial magnet is secured inside the cap; and
a design cover attached to the external wall of the cap.
